(19) United States
(12) Patent Application Publication
(10) Pub. No.: US 2003/0129218 A1
(43) Pub. Date: Jul. 10, 2003

(54) Dietary supplement

(76) Inventor: Eliezer Smoler, Gan Yavneh (IL)

Correspondence Address: Oliff & Berridge, PO Box 19928, Alexandria, VA, 22320, US

(21) Appl. No.: 10/169,325

(22) PCT Filed: Dec. 29, 2000
(86) PCT No.: PCT/IL00/00874

(30) Foreign Application Priority Data
Dec. 31, 1999 (IL) 133851

(51) Int. Cl. A61K 38/43; A23K 1/165; A23K 1/17

(52) U.S. Cl. 424/442; 424/94.1; 514/562; 514/564

(57) ABSTRACT

A dietary supplement for animals comprising one or more enzymes and a physiologically acceptable carrier.

### FIELD OF THE INVENTION

The present invention relates to compositions and methods of using them as dietary supplements for animals to produce modified milk or meat. The invention further relates to milk or meat produced by such methods and to processed products such as cheese derived therefrom.

### BACKGROUND OF THE INVENTION

Improving the quality of milk or meat produced by farm animals is of importance to farmers as well as the dairy and packing industries. For example increasing the concentration of protein in milk increases its commercial value for the producer and increases its nutritional value for the consumer. However, it is difficult to influence the protein concentration in milk by dietary manipulations.

Rogers et al. (J. Dairy Sci., 72:1800-1817, 1989) discloses increasing protein in milk by introducing protein into the abomasum of dairy cows. This may be accomplished either by infusion into the abomasum or in the form of a per os dietary supplement stable in the rumen. However, the efficiency with which casein the major milk protein, enhances milk protein synthesis by this method rarely exceeds 20% (output/input). Moreover, the increase in protein tends to be associated with increased milk volume so that the protein concentration remains unaltered. This method, therefore, does not increase the efficiency of milk production.

It is also known to use amino acids as a dietary supplement for increasing milk protein concentration, for example as disclosed in Published U.K. Patent Application No. GB 2,297,485.

U.S. Pat. No. 5,143,737 discloses a dietary supplement containing unsaturated fatty acids encapsulated by protein. Ruminant animals receiving the supplement were found to produce milk or meat of modified fat content.

### SUMMARY OF THE INVENTION

The present invention is based on the unexpected finding that introduction of enzymes into the digestive tract of animals increases food consumption by the animals and enhances the digestability of their diet. Without wishing to be bound by a particular theory, it is believed that the invention increases the breakdown of dietary nutrients in the digestive tract and thereby increases available oligo saccharides and oligopeptides for digestion. It is further believed that the invention stimulates overall metabolism in the animal.

The invention thus provides a dietary supplement for animals comprising one or more enzymes and a physiological acceptable carrier. In accordance with the invention enzymes that may be included in the dietary supplement include amylase, protease cellulase, xylanase, pectase and phytase. Use of the dietary supplement of the invention enhances meat production. In lactating animals, use of the dietary supplement of the invention leads to a significant increase in the protein concentration of milk without causing a significant increase in milk volume. The invention thus provides methods for increasing meat production by an animal and for the meat so produced. The invention also provides methods for increasing the protein content of an animal's milk and the milk produced by the methods.

In the case of ruminant animals, the enzymes may be provided to the animals by infusion into the abomasum. Alternatively, the enzymes may be provided as a per os dietary supplement in the form of coated pellets. The coating is designed to protect the enzymes and prevent their degradation as they pass through the rumen, and to release the active enzymes in the abomasum. In non-ruminating animals, the supplement may be infused into the gut or provided as a per os dietary supplement in the form of pellets that are coated so as to protect the enzymes and prevent their degradation in the stomach. Coatings for protecting dietary supplements in the rumen or stomach are know in the art, for example, as disclosed in Neudor et al. Br. J. Nutr. 25, 343 (1971); Papas et al. J. D. Sci. 67, 545 (1984); and Wu et al. In controlled release of pesticides and pharmaceuticals, Plenum Press. New York, N.Y., pp 319-331, (1981).

In its first aspect, the invention thus provides a dietary supplement for animals comprising one or more enzymes and a physiologically acceptable carrier.

In its second aspect, the invention provides a method for increasing the protein content of an animal's milk comprising administering the dietary supplement to the animal.

In its third aspect, the invention provides a method for increasing the meat of an animal comprising administering the dietary supplement to the animal.

### EXAMPLES

### Example 1

A feeding experiment of 2 months duration was conducted at The Volcani Agricultural Research Center, Bet Dagan, Israel. The experiment involved 4 dairy cows that were fed ad libitum the diet described in Tables 1 and 2. Table 1 gives the composition and Table 2 gives the chemical analysis of the diet. The cows were at the end of their second milking semester and were all in a late stage of pregnancy. Each cow underwent 4 episodes of treatment lasting 11 days separated by episodes of no treatment also of 11 days. Each treatment consisted of infusion into the abomasum of 1 kg/day of a different dietary supplement. The supplements used were denoted by S19 S20 and S21, and are described in Table3. Supplement S19 contained an enzyme stock mixture consisting of 2,500 units/kg protease, 150 units/kg amylase, and 1,500 units/kg xylanase. The other two supplements S20 and S21 contained no enzymes, but contained the major milk protein cassein. Each supplement was administered to the cows in 10 equally spaced daily doses infused into the abomasum in the form of an aqueous solution of 1 kg supplement dissolved in 5 liters water. The composition of each dosage provided to the cows was determined as prescribed by The Association of Official Analytical Chemists (Official Methods of Analysis of AOAC International, 16^{th} edition, 1996, Arlington. Va.) The cows were allowed to adjust to the supplement during the first 8 days of each 11-day period. During the last 3 days of each period, milk samples were taken for determination of milk composition using a Milko Scan™. Blood samples were taken for determination of blood glucose and urea. The daily food consumption of each cow was also recorded.

The results of Table 3 show that the daily food consumption of the cows when receiving supplement S19 was similar to that when receiving the other supplements or no supplement. However, when receiving S19 the protein content and cost comparison of the milk were significantly improved. The difference is particularly noticeable in morning milking. In addition to elevated protein and lactose in the milk, milk production, protein production, lactose production and cost compared milk were significantly increased. In the evening, milk, lactose and fat concentrations were significantly increased.

TABLE 1
Composition of the Diet

| Ingredient | % dry weight |
|---|---|
| Corn grain | 18.1 |
| Wheat hay | 3.7 |
| Wheat silage | 11.3 |
| Corn silage | 8.1 |
| Wheat bran | 6.5 |
| Rape seed meal | 2.6 |
| Alfalfa wafers | 2.6 |
| Concentrate feed 5.99 5.99 | 33.0 |
| Protein feed | 5.9 |
| Aspargilus waste (Lemonith) | 6.0 |
| Gluten feed 19.5 | 2.4 |

TABLE 2
Chemical Analysis of the Diet

| | % dry weight |
|---|---|
| Dry matter | 65.1 |
| Organic matter | 94.0 |
| Digestible organic matter | 54.5 |
| Total protein | 17.0 |
| Total digestible protein | 11.2 |
| Net energy for milk | 1.74 |
| Cell wall | 33.0 |
| Cell wall from ruffage | 17.5 |
| Effective cell wall | 13.9 |
| Non structural carbohydrates | 38.0 |
| Lysine (gr/kg) | 7.34 |
| Methionin (gr/kg) | 2.08 |
| Histidine (gr/kg) | 2.66 |
| Leucine (gr/kg) | 9.49 |

TABLE 3
Composition of dietary supplements

| | S19 | S20 | S21 |
|---|---|---|---|
| Moisture (%) | 7.8 | 9.54 | 8.42 |
| Ash (%) | 0.5-1.5 | 0.5-1.5 | 0.5-1.5 |
| Protein (%) | 10.0-15.0 | 20.0-30.0 | 20.0-30.0 |
| Diluent medium (%) | 50-80 | 50-80 | 50-80 |
| carbohydrates | | | |
| from corn or wheat grains | | | |
| Enzyme stock mixture* (%) | 0.5-5 | 0 | 0 |
| Casein (%) | 0 | 10.0-20.0 | 10.0-20.0 |

*The enzyme stock mixture consisted of 2,500 units/kg protease, 150 units/kg amylase, and 1,500 units/kg xylanase.

TABLE 4
Effects of dietary supplements on milk production

| | TREATMENT | | | | |
|---|---|---|---|---|---|
| | | | | | STANDARD |
| | CONTROL | S19 | S20 | S21 | ERROR |
| Consumption of dry material (Kg/day) | 17.9 | 18.3 | 16.9 | 16.5 | 1.51 |
| Milk production (Kg/day) | 20.6 | 20.8 | 20.0 | 20.2 | 1.99 |
| Fat (%) | 4.29 | 4.26 | 4.38 | 4.47 | 1.95 |
| Fat (Kg/day) | 0.871 | 0.869 | 0.855 | 0.888 | 0.111 |
| Protein (%) | 3.69 | 3.79 | 3.71 | 3.65 | 0.12 |
| Protein (Kg/day) | 0.738 | 0.770 | 0.725 | 0.724 | 0.033 |
| Lactose (%) | 4.84 | 4.93 | 4.80 | 4.76 | 0.17 |
| Lactose (Kg/day) | 0.981 | 1.017 | 0.954 | 0.964 | 0.063 |
| Cost compared milk (Kg/day) | 26.3 | 27.1 | 25.9 | 26.1 | 1.81 |
| Efficiency of milk production | 1.47 | 1.40 | 1.45 | 1.49 | |
| Morning Milking: | | | | | |
| Milk production (Kg/day) | 13.1 | 13.9 | 12.4 | 12.7 | 0.838 |
| Fat (%) | 4.14 | 4.10 | 4.36 | 4.60 | 0.361 |
| Fat (Kg/day) | 0.542 | 0.570 | 0.541 | 0.584 | 0.075 |
| Protein (%) | 3.69 | 3.83 | 3.72 | 3.63 | 0.019 |
| Protein (Kg/day) | 0.483 | 0.532 | 0.461 | 0.461 | 0.026 |
| Lactose (%) | 4.82 | 4.93 | 4.80 | 4.81 | 0.029 |
| Lactose (Kg/day) | 0.631 | 0.685 | 0.595 | 0.611 | 0.022 |
| Cost compared milk (Kg/day) | 15.7 | 17.1 | 15.3 | 15.6 | 1.89 |
| Evening Milking: | | | | | |
| Milk production (Kg/day) | 7.5 | 6.9 | 7.5 | 7.5 | 1.07 |
| Fat (%) | 4.55 | 4.66 | 4.23 | 4.24 | 0.155 |
| Fat (Kg/day) | 0.341 | 0.322 | 0.317 | 0.318 | 0.027 |
| Protein (%) | 3.70 | 3.72 | 3.68 | 3.67 | 0.021 |
| Protein (Kg/day) | 0.278 | 0.257 | 0.276 | 0.275 | 0.016 |
| Lactose (%) | 4.87 | 4.91 | 4.78 | 4.69 | 0.26 |
| Lactose (Kg/day) | 0.365 | 0.339 | 0.359 | 0.352 | 0.029 |
| Cost compared milk (Kg/day) | 8.6 | 8.0 | 8.7 | 8.6 | 1.65 |

### Example 2

99 black/white calves of non-suckling age (70-80 days) having an initial weight of 78 Kg were secluded for one week prior to the onset of the experiment. They were then weighed and divided into a control group of 50 calves and an experimental group of 49 calves. Calves in the control group were fed ad libitum the mixture described in Tables 5 and 6. Table 5 gives the composition and Table 6 gives the chemical analysis of the mixture. The experimental group was fed the same mixture supplemented with 5 Kg/ton of the supplement S19 described in Example 1 above. The supplement was added to the feed mixture in the form of pellets that were coated so as to prevent breakdown of the pellets as they pass through the rumen. The coating consisted of fatty acids and cellulose as disclosed in Schwab in Biotechnology in Animal Feeds and Animal Feeding, R. J. Wallace and P. A. Chesson, eds., pp 120-137, 1995. The mixtures were checked once a month for dry weight, protein, ash, NDF, ADF and minerals. Daily food intake for each calf was determined. The calves were weighed on day 60 of the experiment.

The results are shown in Table 7. Calves in both groups consumed feed at about the same rate. Calves receiving the supplement showed a weight increase of 63.6 Kg while calves in the control group showed an increase of only 60.6 Kg.

The weight increase of the calves receiving the supplement was thus over 5% greater than that of the control calves. Calves receiving the supplement and initially weighting in a range between 62 and 75 Kg showed an average weight increase (58 Kg) that was 8.4% greater than that of the control calves. Calves receiving the supplement will thus produce more meat than control calves.

TABLE 5
Composition of diet fed to control calves

| | % |
|---|---|
| Soybean meal | 1.18 |
| Cotton grain | 9.04 |
| Barley grain | 35.3 |
| Rye | 5.42 |
| Klimole (1:1 mixture of soy bean | 9.04 |
| molasses and soy bean hulls) | |
| Remolage | 9.04 |
| Corn meal | 18.08 |
| Fish meal | 0.9 |
| Corn grain | 9.73 |
| Calcium and Salt | 1.99 |
| Bosporo and Vitamins | 0.27 |

TABLE 6
Chemical analysis of diet

| | % |
|---|---|
| Dry weight | 72.0 |
| Protein | 16.5 |
| Net Energy (MCal/kg) | 1.84 |
| Crude fiber | 11.2 |
| Calcium | 1.03 |
| Phosphorous | 0.5 |
| Ruffage | 11.8 |
| Vitamin A (1000 i.u./Kg) | 10 |
| Salt | 0.55 |

TABLE 7

| | Control | Experimental | % |
|---|---|---|---|
| | Group | Group | Change |
| Number of calves | 50 | 49 | |
| Feed consumption (Kg) | 13500 | 13350 | |
| Daily feed consumption (Kg) | 4.5 | 4.45 | 6.2 |
| Initial weight (Kg) | 78.32 | 78.24 | 0.1 |
| Weight after 60 days (Kg) | 138.9 | 141.9 | 2.15 |
| Weight increase (Kg) | 60.6 | 63.6 | 4.95 |
| Daily weight increase (Kg) | 1.010 | 1.061 | 5.05 |
| Feed utilization | 4.45 | 4.19 | 6.2 |
| Calves weighing 62-75 Kg | | | |
| Number of calves | 12 | 20 | |
| Initial weight (Kg) | 69.3 | 71.0 | 2.5 |
| Weight after 60 days (Kg) | 122.8 | 129.0 | 5.0 |
| Weight increase (Kg) | 53.5 | 58.0 | 8.4 |
| Daily weight increase (Kg) | 0.892 | 0.967 | 8.4 |
| Calves weighing 76-85 (Kg) | | | |
| Number of calves | 30 | 22 | |
| Initial weight (Kg) | 79.3 | 80.5 | 1.5 |
| Weight after 60 days (Kg) | 141.1 | 146.7 | 3.97 |
| Weight increase (Kg) | 61.8 | 66.2 | 7.1 |
| Daily weight increase (Kg) | 1.030 | 1.103 | 7.1 |
| Calves weighing over 86 Kg | | | |
| Number of calves | 8 | 7 | |
| Initial weight (Kg) | 88.3 | 91.7 | 3.9 |
| Weight after 60 days (Kg) | 155.1 | 163.4 | 5.4 |
| Weight increase (Kg) | 66.9 | 71.7 | 7.2 |
| Daily weight increase (Kg) | 1.115 | 1.195 | 7.2 |

### Example 3

470 high yielding cows in a commercial herd were fed the diet given in Table 8. A chemical analysis of this diet is shown in Table 9. Experimental cows were fed the diet given in Table 8 supplemented with 0.5-5.0% of an enzyme stock mixture consisting of 2,500 units/kgs protease, 150 units/kg amylase and 1,500 units/kg xylanase and the amino acids lysine (10%) and methionine (10%). The cows were fed the diet for three months, from Jun. 1, 2000,to Aug. 30, 2000. During this period milk production by the experimental cows increased by 2 liters per day. Towards the end of this period, an increase in the concentration of the protein in the milk was observed.

On Sep. 1, 2000, the experimental cows were no longer fed the enzyme additive. The concentration of protein in the milk continued to increase after the additive was no longer given. The amount of milk produced by the cows decreased by about 2 liters to the level of milk production prior to giving the additive. On Oct. 8, 2000, the additive was returned to the diet. Milk production then increased in response by about 2 liters per day.

TABLE 8

| Ingredient | Amount (kg) |
|---|---|
| Alfalfa hay | 1.500 |
| Maize silage | 4.661 |
| Wheat silage | 9.000 |
| Cracked barley | 1.000 |
| Soybean meal | 2.587 |
| Citrus peels | 2.796 |
| Wheat bran | 0.500 |
| Na₂CO₃ MgO | 0.160 |
| Gluten feed | 0.500 |
| Protected fat | 0.367 |
| Wheat hay | 1.700 |
| Cracked corn | 1.500 |
| Potatoes | 15.000 |
| Cotton seed | 0.500 |
| Almond hulls | 0.915 |
| Corn cobs | 4.000 |
| Limestone | 0.150 |
| NaCl | 0.093 |
| Vitamins | 0.043 |
| Wheat | 1.279 |
| Yeast | 0.010 |
| Fishmeal | 0.100 |
| Feathermeal | 0.050 |
| Soybean | 1.439 |
| Soybean oil | 0.030 |
| Poultry meat meal | 0.050 |
| Glucose 70% | 1.000 |
| Corn germ meal | 1.360 |

TABLE 9

| Ingredient | Amount |
|---|---|
| Dry matter (Kg/day) | 23.561 |
| Protein (Kg/day) | 4.005 |
| Ruffage (Kg/day) | 8.246 |
| Calcium (Kg/day) | 0.200 |
| Phosphorous (Kg/day) | 0.090 |
| Vitamin A (units/day) | 180000.000 |
| Acid detergent fiber (ADF) (Kg/day) | 3.666 |
| Neutral detergent fiber (NDF) (Kg/day) | 7.068 |
| Net energy for lactation (Calories/day) | 42.457 |
| Non structural carbohydrates (Kg/day) | 9149.046 |
| Cell wall ruffage (Kg/day) | 4.241 |
| Fat (Kg/day) | 1.175 |
| NaCl (Kg/day) | 0.090 |
| Undegradable protein (Kg/day) | 1206.773 |
| Methionine (gr/day) | 89.885 |
| Lysine (gr/day) | 190.000 |
| Degradable protein (gr/day) | 2626.349 |
| Degradable organic matter (gr/day) | 12392.940 |

1. A dietary supplement for animals comprising one or more enzymes and a physiologically acceptable carrier.

2. The dietary supplement of claim 1 comprising one or more digestive enzymes.

3. The dietary supplement of claim 1 or 2 wherein the one or more enzymes are selected from the group consisting of, amylase, protease, cellulase, xylanase, pectase; and phytase.

4. The dietary supplement according to any one of claims 1 to 3, wherein the dietary supplement is S19.

5. The dietary supplement according to any one of the previous claims further comprising one or more amino acids.

6. The dietary supplement according to claim 5, wherein the one or more amino acids includes lysine.

7. The dietary supplement according to claim 6, wherein the lysine is present in a concentration of 1-30%.

8. The dietary supplement according to claim 5, wherein the one or more amino acids includes methionine.

9. The dietary supplement according to claim 8, wherein the methionine is present in a concentration of 1-20%.

10. A method for increasing the protein content of an animal's milk comprising administering to the animal a dietary supplement according to any one of the previous claims.

11. The method of claim 10, wherein the animal is a ruminating animal.

12. The method of claim 11, wherein the dietary supplement is administered to the ruminating animal per os.

13. The method of claim 12, wherein the dietary supplement is administered to the ruminating animal per os in the form of pellets that are coated so as to protect the dietary supplement in the rumen of the ruminating animal.

14. The method of claim 11, wherein the dietary supplement is administered to the ruminating animal by infusion into the abomasum.

15. The method of any one of claims 1 to 9, wherein the ruminating animal is bovine.

16. The method of claims 10, wherein the animal is a non-ruminating animal.

17. The method of claim 16, wherein the dietary supplement is administered to the non-ruminating animal per os.

18. The method of claim 17, wherein the dietary supplement is administered to the animal per os in the form of pellets that are coated so as to protect the dietary supplement in the stomach of the non-ruminating animal.

19. The method of claim 11, wherein the dietary supplement is administered to the non-ruminating animal by infusion into the gut.

20. A method for increasing the meat of an animal comprising administering to the animal a dietary supplement according to any one of claims 1 to 4.

21. The method of claim 20, wherein the animal is a ruminating animal.

22. The method of claim 21, wherein the dietary supplement is administered to the ruminating animal per os.

23. The method of claim 22, wherein the dietary supplement is administered to the ruminating animal per os in the form of pellets that are coated so as to protect the dietary supplement in the rumen of the ruminating animal.

24. The method of claim 21, wherein the dietary supplement is administered to the ruminating animal by infusion into the abomasum.

25. The method of any one of claims 21 to 23 wherein the ruminating animal is bovine.

26. The method of claims 20 wherein the animal is a non-ruminating animal.

27. The method of claim 26 wherein the dietary supplement is administered to the non-ruminating animal per os.

28. The method of claim 27 wherein the dietary supplement is administered to the animal per os in the form of pellets that are coated so as to protect the dietary supplement in the stomach of the non-ruminating animal.

29. The method of claim 11, wherein the dietary supplement is administered to the non-ruminating animal by infusion into the gut.

30. Milk produced by the method of any one of claims 10 to 19.

31. A milk product containing the milk of claim 29.

32. Meat produced by the method of any one of claims 20 to 29.

33. A meat product comprising the meat of claim 32.
